(19) United States
(12) Patent Application Publication
(10) Pub. No.: US 2025/0332698 A1
(43) Pub. Date: Oct. 30, 2025

(54) MULTI-ANGULAR TOOL FOR DETACHING AN ANNULAR ELEMENT FROM AN AXLE

(71) Applicant: CHIEN YU HONG CO., LTD., Taichung City (TW)

(72) Inventor: Chang-Ta Tsai, Taichung City (TW)

(21) Appl. No.: 18/648,159

(22) Filed: Apr. 26, 2024

(51) Int. Cl. B25B 27/02

(52) U.S. Cl. CPC B25B 27/023

(57) ABSTRACT

A multi-angular tool for detaching an annular element from an axle includes a rod, a sliding element, multiple hooking elements and multiple pivotal elements. The sliding element is movably connected to the rod. Each of the pivotal elements includes a first end pivotally connected to the sliding element about a first axis and a second end pivotally connected to a corresponding one of the hooking elements about a second axis.

### BACKGROUND OF INVENTION

### 1. Field of Invention

The present invention relates to an annular element on an axle and, more particularly, to a multi-angular tool for detaching an annular element from an axle.

### 2. Related Prior Art

An annular element such as a gear, a pulley and an annular element is provided on an axle or a shaft. Such a sliding element is detached from such an axle for maintenance, repair or replacement. To this end, a tool is needed.

Such a tool includes a rod, a sliding element movable along the rod, and hooks pivotally connected to the sliding element. In operation, an end of the rod is abutted against an end of the axle. The hooks are engaged with the annular element. Then, the sliding element is moved toward another end of the rod along the rod, thereby detaching the annular element from the axle.

Such tools are disclosed in Patent Nos. TWI797503, TWI811065, TWI815626, U.S. Pat. No. 6,665,918, U.S. Pat. No. 11,819,985 and U.S. Pat. No. 8,015,683 for example.

Each of the hooks of each of the tools is formed with a barb extending from an end in fixed sense of direction. However, it sometimes desirable to have the barbs extending from the hooks in other directions for effective engagement with the annular element. For example, the barbs are expected to extend from the hooks in a sense of direction when the tool is used to disengage an annular element from an axle while the barbs are expected to extend from the hooks in a different sense of direction when the tool is used to disengage a pulley from an axle.

The present invention is therefore intended to obviate or at least alleviate the problems encountered in the prior art.

### SUMMARY OF INVENTION

It is the primary objective of the present invention to provide a multiple-angular tool for detaching a sliding element from a rod.

To achieve the foregoing objective, the multi-angular tool includes a rod, a sliding element, multiple hooking elements and multiple pivotal elements. The sliding element is movably connected to the rod. Each of the pivotal elements includes a first end pivotally connected to the sliding element about a first axis and a second end pivotally connected to a corresponding one of the hooking elements about a second axis.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a multi-angular tool for detaching an annular element from an axle according to the preferred embodiment of the present invention;

FIG. 2 is an exploded view of the multi-angular tool shown in FIG. 1;

FIG. 3 is another exploded view of the multi-angular tool than shown in FIG. 2; and

FIG. 4 is another perspective view of the multi-angular tool than shown in FIG. 1.

### DETAILED DESCRIPTION OF PREFERRED EMBODIMENT

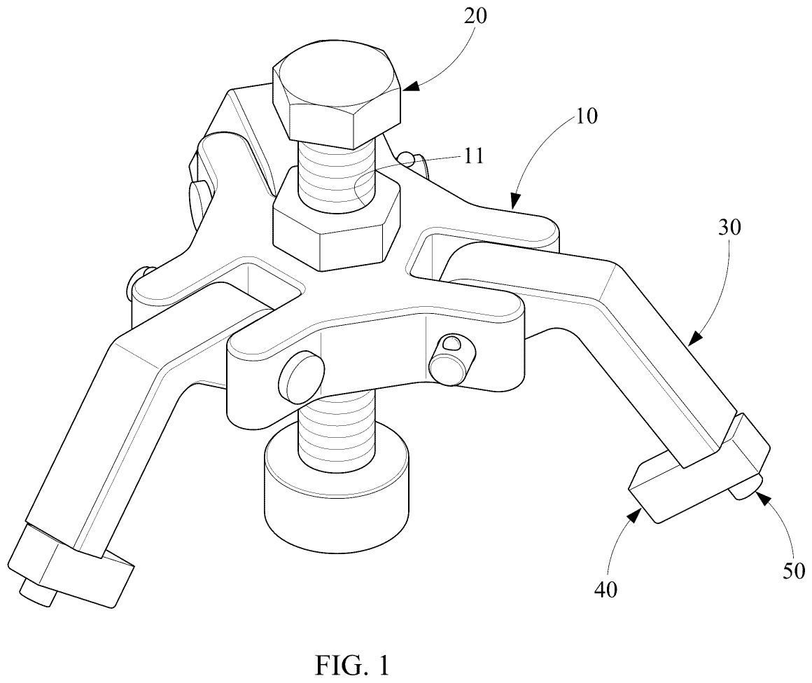

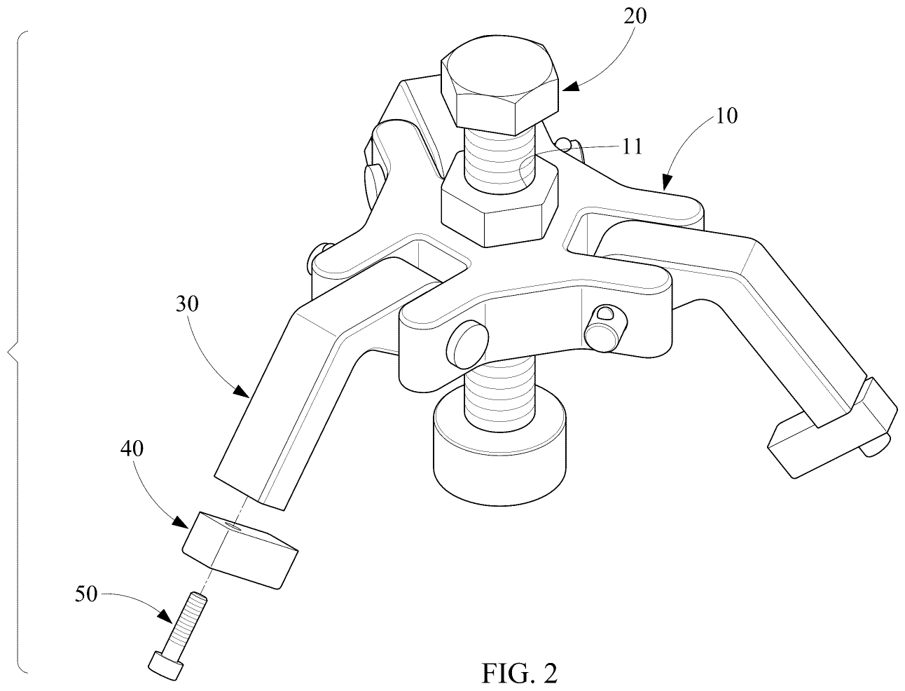

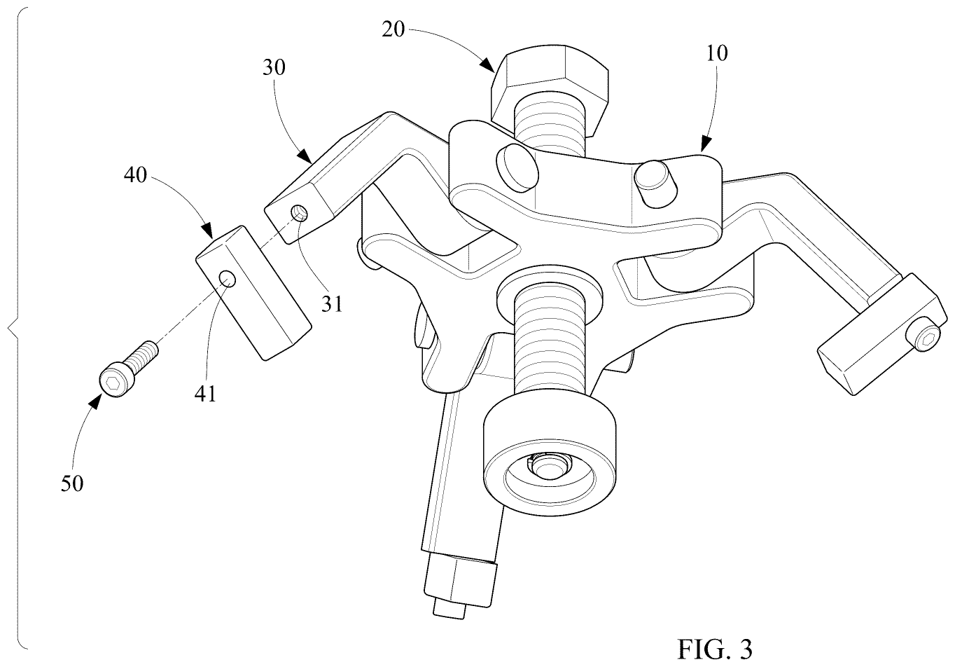

Referring to FIGS. 1 through 4, a multi-angular tool for detaching an annular element from an axle includes a sliding element 10, a rod 20, multiple pivotal elements 30, multiple hooking elements 40 and multiple fasteners 50 according to the preferred embodiment of the present invention.

The sliding element 10 (the prior art) includes a screw hole 11 extending axially throughout the sliding element 10.

The rod 20 (the prior art) includes a threaded section (not numbered) inserted in the screw hole 11 of the sliding element 10.

Each of the pivotal elements 30 includes a first end pivotally connected to the sliding element 10 and a second end pivotally connected to a corresponding one of the hooking elements 40. Each of the pivotal elements 30 is pivotable relative to the sliding element 10 about an axis and pivotable relative to the corresponding barb 40 about another axis. Each of the pivotal elements 30 includes a screw hole 31.

Each of the hooking elements 40 includes an aperture 41.

Each of the fasteners 50 extends throughout the aperture 41 of a corresponding one of the hooking elements 40. Each of the fasteners 50 is preferably a screw formed with a threaded section (not numbered) inserted in the screw hole 31 of a corresponding one of the pivotal element 30. Thus, each of the hooking elements 40 is pivotally connected to the second end of the corresponding pivotal element 30.

In use, an end of the rod 20 is abutted against an end of an axle (not shown). The hooking elements 40 are engaged with an annular element (not shown). Then, the rod 20 is rotated relative to the sliding element 10, thereby moving the sliding element 10 toward another end of the rod 20 along the rod 20. Thus, the annular element is detached from the axle.

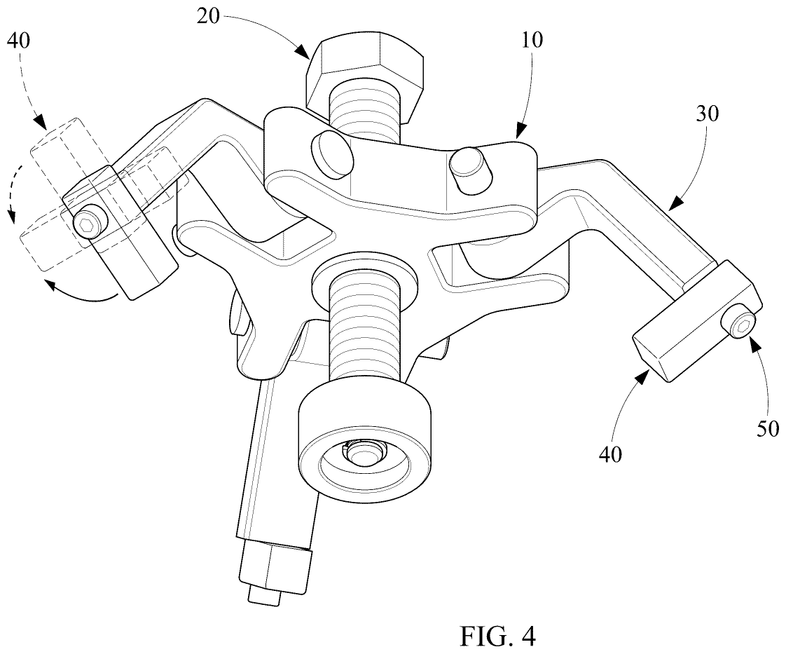

Referring to FIG. 4, each of the hooking elements 40 rotatable relative to the corresponding pivotal element 30 about the corresponding fastener 50. Thus, each of the hooking elements 40 is in a desired angle relative to the corresponding pivotal element 30 so that each of the hooking element 40 is engageable with an internal or external portion of the annular element.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A multi-angular tool for detaching an annular element from an axle, wherein the multi-angular tool comprising:
a rod 20;
a sliding element 10 movably connected to the rod 20;
multiple hooking elements 40; and
multiple pivotal elements 30 each of which comprises a first end pivotally connected to the sliding element 10 about a first axis and a second end pivotally connected to a corresponding one of the hooking elements 40 about a second axis.

2. The multi-angular tool according to claim 1, further comprising the fasteners 50 for pivotally connecting the hooking elements 40 to the pivotal elements 30.

3. The multi-angular tool according to claim 2, wherein the fasteners 50 are screws, wherein each of the pivotal elements 30 comprises a screw hole 31 for receiving a corresponding one of the fasteners 50.

4. The multi-angular tool according to claim 1, wherein the rod 20 comprises a threaded section, wherein the sliding element 10 is formed with a screw hole 11 for receiving the threaded section of the rod 20.
